(19) United States
(12) Patent Application Publication
(10) Pub. No.: US 2019/0024649 A1
(43) Pub. Date: Jan. 24, 2019

(54) PLASTIC AIR PUMP MOVEMENT

(71) Applicant: Guangzhou Antu Electric Co., Ltd., Guangzhou (CN)

(72) Inventor: Xinhua Kuang, Guangzhou (CN)

(21) Appl. No.: 15/698,675

(22) Filed: Sep. 8, 2017

(30) Foreign Application Priority Data
Jul. 18, 2017 (CN) 201710589725.2

(51) Int. Cl. F04B 35/06; B60S 5/04; F04B 39/12

(52) U.S. Cl. CPC F04B 35/06; F04B 39/121; B60S 5/04

(57) ABSTRACT

A plastic air pump movement comprises a plastic cylinder, a plastic piston, a plastic output plate and a power mechanism, wherein the power mechanism comprises a plastic gear, a plastic swing arm and a motor. It further comprises a plastic support for fixing and supporting the motor, the plastic gear, the plastic swing arm and the plastic cylinder. The plastic output plate is fixedly connected with the plastic cylinder by a rotary snap-fit joint. The plastic support is fixedly connected with the motor and the plastic cylinder by rotary snap-fit joints. The plastic air pump movement is integrally arranged within a plastic housing. A groove fitting with the plastic cylinder, the plastic output plate, the plastic support, the plastic swing arm, the plastic gear and the motor is provided within the plastic housing. Due to the components made of plastic material, it has light weight.

### CROSS-REFERENCE TO PRIOR APPLICATION

This application claims the benefit of Chinese Patent Application No. 201710589725.2 filed on Jul. 18, 2017, the contents of which are incorporated herein by reference.

### FIELD OF THE INVENTION

The present invention relates to a plastic air pump movement.

### BACKGROUND OF THE INVENTION

Air pump movement is a main functional component of the air pump which is also known as the blast pump or the inflator. The air pump movement provides power through the rotation of the motor and drives the piston to compress gas, and then outputs the compressed air, thereby achieving inflation function. The air pump movement works as follows. As the motor works, in order to extract the air, the valve of the communicating vessel is opened under air pressure so as to allow the air to enter the air cylinder. In order to inflate the tire, the valve of the communicating vessel is closed due to air pressure so as to allow the air to enter the tire.

Now the air pumps are widely used in the fields such as the automotives, the motorcycle, the bicycles, the rubber balls and the rubber boats. In the event that the tire is punctured by a nail or any other stiff stuff in the middle of nowhere, an air pump for temporarily pumping up the tire will be greatly needed to ensure normal running. Furthermore, correct tire pressures for the car are crucial for the fuel efficiency of the car, the driving safety, the tire life, and the vehicle performance as well. By periodical detection of tire pressure by means of the air pump and by the pumping-up of the tire in case of low tire pressure, the tire and wheel hub both can be protected and given longer service lives.

The connection mechanisms of the existing air pump movements usually comprise a motor, a support, a gear, a support shaft, a piston, a cylinder, etc. The motor is arranged on the support, and an output end of the motor is connected with the gear which is engaged with a reduction gear. The support shaft is fittedly connected with the support and is arranged in such a manner that the support shaft is capable of driving the piston to move in the cylinder to compress air. Since the motor provides power to achieve a certain air pressure, all components of the air pump are under a certain pressure and thus are required to have the characteristics of high temperature resistance, high pressure resistance, abrasion resistance, impact resistance, and so on. The air pumps now on the market are made of alloy materials. Although they meet the requirements for each component, they have some weights that cause inconvenience during using, and they also have high prices because of which not all vehicles may be provided with the air pumps and thus are disadvantageous for the popularity. Furthermore, due to the weights, the oil consumptions of the vehicles carrying them are increased, which lead to the waste of resources at a certain extent.

In conclusion, an air pump movement with light weight and low price is needed, which may be portably carried in the vehicle and cause lower oil consumption, and may be easy to take and use to pump up the tire. In case of any emergency, it may be used to pump up the tire in time, thereby preventing the vehicle from being not available due to lower tire pressure.

Hence, it is necessary to solve the industry problem of how to provide an air pump movement which has low price, light weight and may be portably carried in the vehicle.

### SUMMARY OF THE INVENTION

Aiming at the disadvantages existed in the art, the present invention aims to provide a plastic air pump movement which has light weight, low cost, convenient installation, and is portably carried in the vehicle and is easy to use.

To this end, the present invention provides a plastic air pump movement, comprising: a plastic cylinder, a plastic piston, a plastic output plate and a power mechanism, wherein the power mechanism comprises a plastic gear, a plastic swing arm, and a motor.

The air pump movement further comprises a plastic support for fixing and supporting the motor, the plastic gear, the plastic swing arm and the plastic cylinder.

The plastic output plate is fixedly connected with the plastic cylinder by a rotary snap-fit joint, and the plastic support is fixedly connected with both the motor and the plastic cylinder by rotary snap-fit joints.

The plastic air pump movement is integrally arranged within a plastic housing. A groove, which fits with the plastic cylinder, the plastic output plate, the plastic support, the plastic swing arm, the plastic gear and the motor, is provided within the plastic housing.

In the present invention, all components of the air pump movement, except for the motor, are made of plastic products with specific material compositions instead of the alloy components provided in existing air pumps, and those components are connected in a rotary snap-fitting manner, thereby greatly reducing the weight of the air pump movement, facilitating convenient assembly and mounting of the air pump movement product, conducive to efficient production for the manufacturer, and greatly lowing the cost. Since the air pump movement is fixed within a plastic housing, it is fixed and supported. Due to the groove respectively fixing individual components, during inflation, the inconvenience caused by the components affected by the inertia resulting from larger impact force generated by the rotation of the motor is avoided.

The plastic air pump movement according to the present invention has a regular shape, which facilitates convenient carrying. It has light weight and may be portably carried in the vehicle at any time. It can be easily spread and effectively meets the need of the air pump for inflating when the tire is deflated.

When the air pump movement works, the motor is rotated, and a pressure is produced. Hence, all components should be made of some material having some properties. Through a lot of experiments and tests, material compositions of each component of the plastic air pump movement according to the present invention can be finally determined. The procedures of the experiments are as follows. Forming the air pump movement with the components made of plastic materials containing various compositions, recurrently inflating for 500 times by means of the air pump movement in a condition that the motor is rotated at a speed of 20000 r/min and the air pressure within the plastic cylinder is 100 psi, and observing the deformation and abrasion conditions of all components. If no deformation or abrasion occurs after 500 times of recurrent inflation, it means that the plastic material with such compositions is capable of withstanding the working conditions of the air pump movement.

According to a particular embodiment of the present invention, the plastic cylinder may be made of PPS plastic material with high strength. The plastic cylinder may be cylindrical shaped, open at both ends. The outer wall of the plastic cylinder may be provided respectively at both upper and lower ends with a protrusion extending around the plastic cylinder.

According to a particular embodiment of the present invention, the plastic output plate may be made from a combination of nylon and 30% to 35% fiberglass. The plastic output plate may be lid shaped, and may be provided with a rotary snap-fit joint which is snap-fitted and connected with a protrusion arranged on an outer wall at an upper end of the plastic cylinder. The plastic output plate may be provided with a round shaped through hole which is fittedly connected with a pneumatic tube.

According to a particular embodiment of the present invention, the plastic support may be made from a combination of nylon and 30% to 35% fiberglass. The plastic support may be provided at the upper end with a rotary snap-fit joint which is snap-fitted and connected with the protrusion arranged on the outer wall at the lower end of the plastic cylinder.

According to a particular embodiment of the present invention, the plastic gear may comprise a big gear and a small gear which are engaged. Both the big gear and the small gear may be arranged in the plastic support. The plastic gear may be made from a combination of nylon and 30% to 35% fiberglass.

According to a particular embodiment of the present invention, the plastic swing arm may be made from a combination of nylon and 30% to 35% fiberglass. The plastic swing arm has two ends, wherein the upper end may be fixedly connected with the plastic piston, and the lower end may be fixedly connected with the bearing of the big gear.

According to a particular embodiment of the present invention, the plastic piston may be made from a combination of nylon and 30% to 35% fiberglass. The plastic piston may be fixedly connected with the plastic swing arm. A sealing ring may be sleeved on the plastic piston within the plastic cylinder. The plastic piston, the sealing ring, and the plastic cylinder may fit with each other and may be sealingly assembled in a movable manner.

According to a particular embodiment of the present invention, the output shaft of the motor has two ends, one of which may be connected with the small gear, and the other may be connected with a fan blade.

According to a particular embodiment of the present invention, the plastic cylinder, the plastic output plate, the plastic support and the motor may be fixedly connected with the plastic housing by the groove.

According to a particular embodiment of the present invention, the plastic housing may be made from a combination of nylon and 30% to 35% fiberglass. The plastic housing may be provided with an air outlet.

Compared with the existing devices, the present invention has advantages as follows.

1. The components of the air pump movement, except for the motor, are made of plastic products with specific material compositions instead of the alloy components provided in existing air pumps, thereby greatly reducing the cost for the manufacturer, reducing the weight of the movement, and facilitating vehicle carrying and convenient use.

2. The plastic components are connected in a rotary snap-fitting manner, which saves materials and facilitates convenient assembly. Only one working positioning is enough for assembling the movement, which greatly saves labor and improves production efficiency for the manufacturer.

3. Since the air pump movement is fixed within a plastic housing, it is fixed and supported. Due to the groove fixing individual components respectively, during inflation, the inconvenience caused by the components affected by the inertia resulting from larger impact force generated by the rotation of the motor is avoided.

4. Due to the plastic housing fixing the air pump movement, a regular shape for the air pump movement is provided, thereby facilitating convenient carrying and preservation.

The present invention will be further explained below in detail in conjunction with figures.

### BRIEF DESCRIPTION OF THE DRAWINGS

FIG. 1 is a schematic view of a plastic air pump movement according to a first embodiment of the present invention;

FIG. 2 is a schematic view of components of the plastic air pump movement according to the first embodiment of the present invention.

### DETAILED DESCRIPTION OF ILLUSTRATED EMBODIMENTS

### Embodiment 1

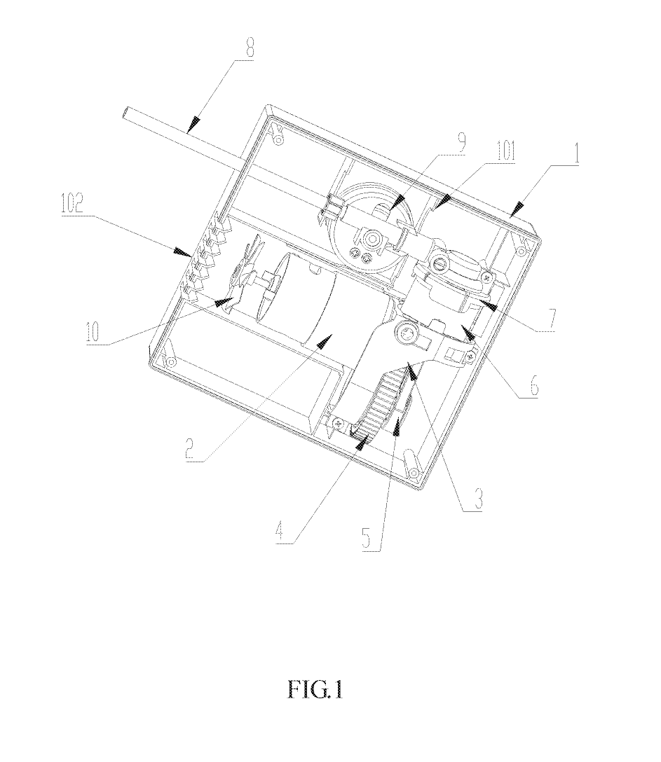

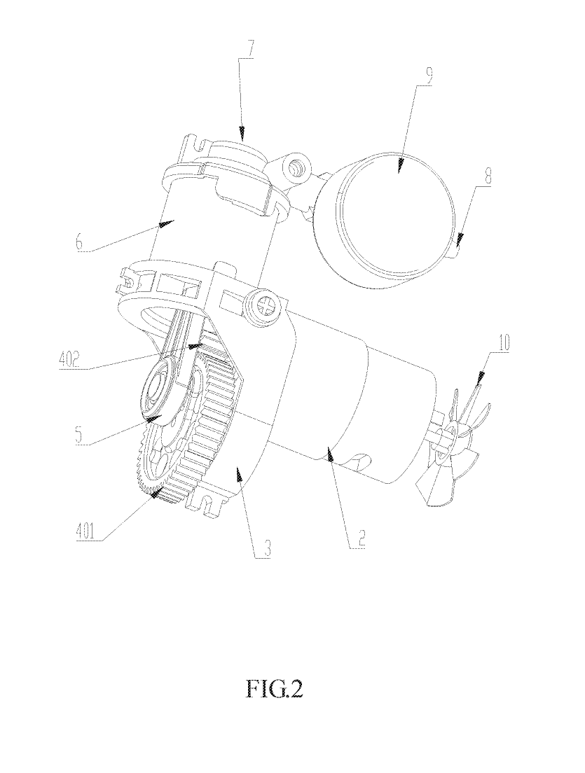

As shown in FIGS. 1-2, the plastic air pump movement according to the first embodiment of the present invention comprises a plastic cylinder 6, a plastic piston (not shown in the figures), a plastic output plate 7 and a power mechanism, and the power mechanism comprises a plastic gear 4, a plastic swing arm 5, and a motor 2.

The air pump movement further comprises a plastic support 3 for fixing and supporting the motor 2, the plastic gear 4, the plastic swing arm 5 and the plastic cylinder 6.

The plastic output plate 7 is fixedly connected with the plastic cylinder 6 by a rotary snap-fit joint, and the plastic support 3 is fixedly connected with both the motor 2 and the plastic cylinder 6 by rotary snap-fit joints.

The plastic air pump movement is integrally arranged within a plastic housing 1. A groove 101, which fits with the plastic cylinder 6, the plastic output plate 7, the plastic support 3, the plastic swing arm 5, the plastic gear 4, and the motor, is provided within the plastic housing 1.

Except for the motor, all components of the plastic air pump movement according to the present embodiment are made of plastics with specific material compositions. Through a lot of experiments and tests, material compositions of each component of the plastic air pump movement according to the present embodiment can be finally determined. The procedures of the experiments are as follows. Forming the air pump movement with the components made of plastic materials containing various compositions, recurrently inflating for 500 times by means of the air pump movement in a condition that the drive motor is rotated at a speed of 20000 r/min and the air pressure within the plastic cylinder is 100 psi, and observing the deformation and abrasion conditions of each component. If no deformation or abrasion occurs after 500 times of recurrent inflation, it means that the plastic material with such compositions is capable of withstanding the working conditions of the air pump movement.

The plastic gear 4 comprises a big gear 401 and a small gear 402 which are engaged. Both the big gear 401 and the small gear 402 are arranged in the plastic support. The plastic gear 4 is made from nylon in combination with 30% to 35% fiberglass. The big gear 401 and the small gear 402 are engaged with each other to rotate. If the gear wears out, the bearing of the big gear 401 may come off from the small gear 402, and the support shaft may be detached from the plastic support 3, thereby resulting in product failure and reducing service life of the air pump movement. The material containing a combination of nylon with 30% to 35% fiberglass has characteristics of high strength and high toughness, and is not easy to wear, and thus is applicable for the gear 4.

The output shaft of the motor 2 has two ends, one of which is connected with the small gear 402, and the other is connected with fan blade 10. When the motor 2 is rotated, the fan blade 10 is driven to rotate by the output shaft, to dissipate heat for the whole air pump movement. Meanwhile, the small gear 402 is driven to rotate by the output shaft, and the big gear 401 is driven to rotate by the small gear 402.

The plastic swing arm 5 has two ends. Herein, an upper end of the plastic swing arm 5 is fixedly connected with the plastic piston. The plastic piston is arranged within the plastic cylinder 6 for compressing the air in the plastic cylinder 6. A sealing ring is sleeved on the plastic piston within the plastic cylinder 6. The plastic piston, the sealing ring, and the plastic cylinder 6 fit with each other and are sealingly assembled in a movable manner. A lower end of the plastic swing arm 5 is connected with the bearing of the big gear 401. When the big gear 401 is rotated, the plastic swing arm 5 is driven to move forward and backward, whereby the plastic piston is driven to move back and forth to compress air. By the back-and-forth reciprocating motions of the plastic piston cooperated with the plastic cylinder 6 and the plastic output plate 7, the tire inflation procedure is carried out. The plastic piston is made from nylon in combination with 30% to 35% fiberglass. The plastic swing arm 5 is made from nylon in combination with 30% to 35% fiberglass.

The plastic output plate 7 substantially is the part through which the compressed air is discharged out. The plastic output plate 7 is lid shaped, and is provided with a rotary snap-fit joint which is snap-fitted and connected with a protrusion arranged on an outer wall at an upper end of the plastic cylinder 6. Since the plastic output plate 7 is disposed at the outlet for the compressed air in the cylinder, it needs to have higher strength and toughness, and be more resistant to high temperature. The plastic output plate 7 is made from nylon in combination with 30% to 35% fiberglass. The plastic output plate 7 is provided with a round shaped through hole which is fittedly connected with a pneumatic tube 8. Due to the reciprocating motions of the plastic piston, the compressed air in the plastic cylinder 6 flows to the pneumatic tube 8, and then flows from the pneumatic tube 8 to the vehicle tire, thereby achieving tire inflation.

The pneumatic tube 8 is arranged with an air pressure gauge 9 for detecting the pressure of the compressed air introduced into the tire in real time, so as to avoid tire burst due to too large tire pressure and avoid under-inflation due to too little tire pressure.

The plastic cylinder 6 is the key part of the air pump movement. When the air pump movement works, the plastic piston makes a reciprocating motion in the plastic cylinder 6 to produce air pressure. Such whole working procedure may produce higher temperature. Meanwhile, the plastic cylinder 6 needs to withstand high pressure. In this case, the plastic cylinder 6 is made of PPS plastic material with high strength. Since the PPS plastic material has high strength and high temperature resistance and is capable of withstanding high temperature over 250 degrees, it meets the requirement for the cylinder of the air pump movement. The plastic cylinder 6 is cylindrical shaped, open at both ends. The outer wall of the plastic cylinder 6 is provided, at both upper and lower ends respectively, with a protrusion extending around the plastic cylinder, so as to connect the plastic output plate 7 and the plastic support 3 in a rotary snap-fitting manner.

The plastic support 3, which is the part for connecting the motor 2, the plastic gear 4 and so on, serves for supporting and fixing the air pump movement and thus has high demands on the material. In the present embodiment, the plastic support 3 is also made from nylon in combination with 30% to 35% fiberglass. Such plastic support has high strength and high toughness. The plastic support 3 is provided at the upper end with a rotary snap-fit joint which is snap-fitted and connected with the protrusion arranged on the outer wall at the lower end of the plastic cylinder 6.

The plastic cylinder 6, the plastic output plate 7, the plastic support 3 and the motor 2 are fixedly connected with the plastic housing 1 by the groove 101. Since the air pump movement is fixed within the plastic housing 1, it is fixed and supported. Due to the groove 101 respectively fixing individual components, during inflation, the inconvenience caused by the components affected by the inertia resulting from larger impact force generated by the rotation of the motor is avoided.

The plastic housing 1, which is the part for supporting and fixing the whole air pump movement, needs to have a certain toughness and strength. It is made from nylon in combination with 30% to 35% fiberglass. The plastic housing 1 is provided with an air outlet 102 for exhausting air and dissipating heat, thereby facilitating longer working lives for the air pump movement.

In the present embodiment, all components of the air pump movement, except for the motor, are made of plastic products with specific material compositions instead of the alloy components provided in existing air pumps, and those components are connected in a rotary snap-fitting manner, thereby greatly reducing the weight of the air pump movement, facilitating convenient assembly and mounting of the air pump movement product, conducive to efficient production for the manufacturer, and greatly lowing the cost. Since the air pump movement is fixed within the plastic housing, it is fixed and supported. Due to the groove fixing individual components respectively, during inflation, the inconvenience caused by the components affected by the inertia resulting from larger impact force generated by the rotation of the motor is avoided. Due to the plastic housing fixing the air pump movement, a regular shape for the air pump movement is provided, thereby facilitating convenient carrying and preservation for the air pump movement. The material of each component in the present embodiment is determined and applied to the air pump movement after a lot of experiments and tests, and the quality and the resistant performances of the air pump movement are ensured.

The plastic air pump movement according to the present embodiment has a regular shape, which facilitates convenient carrying. It has light weight and may be portably carried in the vehicle at any time. It can also be easily spread and effectively meets the need of the air pump for inflating when the tire is deflated.

Although the present invention has been described as above with reference to the preferred embodiments, the intention is not to limit the present invention. Those skilled in the art may modify the above disclosed technical contents without departing from the scope of the present invention. The present invention is intended to cover all equivalent modifications made in accordance with the technical essence of the present invention.

1. A plastic air pump movement, characterized in that: the plastic air pump movement comprises a plastic cylinder, a plastic piston, a plastic output plate and a power mechanism, wherein the power mechanism comprises a plastic gear, a plastic swing arm, and a motor;
wherein the air pump movement further comprises a plastic support for fixing and supporting the motor, the plastic gear, the plastic swing arm and the plastic cylinder;
wherein the plastic output plate is fixedly connected with the plastic cylinder by a rotary snap-fit joint, the plastic support is fixedly connected with both the motor and the plastic cylinder by rotary snap-fit joints;
the plastic air pump movement is integrally arranged within a plastic housing, and a groove which fits with the plastic cylinder, the plastic output plate, the plastic support, the plastic swing arm, the plastic gear and the motor is provided within the plastic housing.

2. The plastic air pump movement according to claim 1, characterized in that: the plastic cylinder is made of PPS plastic material with high strength, the plastic cylinder is cylindrical shaped, open at both ends, and an outer wall of the plastic cylinder is provided respectively at both upper and lower ends with a protrusion extending around the plastic cylinder.

3. The plastic air pump movement according to claim 1, characterized in that: the plastic output plate is made from a combination of nylon and 30% to 35% fiberglass, the plastic output plate is lid shaped, and is provided with the rotary snap-fit joint which is snap-fitted and connected with a protrusion arranged on an outer wall at an upper end of the plastic cylinder, the plastic output plate is provided with a round shaped through hole, and the through hole is fittedly connected with a pneumatic tube.

4. The plastic air pump movement according to claim 1, characterized in that: the plastic support is made from a combination of nylon and 30% to 35% fiberglass, the plastic support is provided at an upper end with the rotary snap-fit joint which is snap-fitted and connected with a protrusion arranged on an outer wall at a lower end of the plastic cylinder.

5. The plastic air pump movement according to claim 1, characterized in that: the plastic gear comprises a big gear and a small gear which are engaged, both the big gear and the small gear are arranged in the plastic support, and the plastic gear is made from a combination of nylon and 30% to 35% fiberglass.

6. The plastic air pump movement according to claim 5, characterized in that: the plastic swing arm is made from a combination of nylon and 30% to 35% fiberglass, and the plastic swing arm has two ends, wherein an upper end is fixedly connected with the plastic piston, and a lower end is fixedly connected with a bearing of the big gear.

7. The plastic air pump movement according to claim 1, characterized in that: the plastic piston is made from a combination of nylon and 30% to 35% fiberglass, the plastic piston is fixedly connected with the plastic swing arm, a sealing ring is sleeved on the plastic piston within the plastic cylinder, and the plastic piston, the sealing ring and the plastic cylinder fit with each other and are sealingly assembled in a movable manner.

8. The plastic air pump movement according to claim 5, characterized in that: an output shaft of the motor has two ends, where one end is connected with the small gear, and the other end is connected with a fan blade.

9. The plastic air pump movement according to claim 1, characterized in that: the plastic cylinder, the plastic output plate, the plastic support and the motor are fixedly connected with the plastic housing by the groove.

10. The plastic air pump movement according to claim 1, characterized in that: the plastic housing is provided with an air outlet.
